(19) United States
(12) Patent Application Publication
(10) Pub. No.: US 2008/0187184 A1
(43) Pub. Date: Aug. 7, 2008

(54) System and method for facial image enhancement

(75) Inventor: Jonathan Yen, San Jose, CA (US)

Correspondence Address: TUCKER ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/701,016

(22) Filed: Feb. 1, 2007

(51) Int. Cl. G06K 9/00

(52) U.S. Cl. 382/118

(57) ABSTRACT

The subject application is directed to a facial image enhancement system and method. Image data, including data representing at least one facial area, is first received. Following receipt of the image data, face region data is isolated from the image data. Luminance data and chrominance data are generated corresponding to the facial area data. A smoothing algorithm is thereafter applied to the generated luminance data, which generates smoothed luminance data. Mapping data is then generated according to at least one non-skin tone region of the image data. Enhanced image data is then generated according to the smoothed luminance data, chrominance data, and mapping data.

### BACKGROUND OF THE INVENTION

The subject application is directed to a system and method for facial image enhancement. More particularly, the subject application is directed to a system and method for facial image enhancement to achieve facial smoothing and to reduce artifacts.

Facial artifacts, including blemishes such as freckles, are common in photographs, particularly in portraits or close up shots. Freckles are generally flat, circular spots developed randomly on the skin, especially after repeated exposure to sunlight. Freckles vary in color, but are always darker than the skin surrounding them as freckles are due to deposits of dark pigment, known as melanin. There are two types of freckles, which are ephelides, appearing in summer months and fading in winter, and lentigines, accumulating over time and do not fade. Ephelides are more common in children, particularly those with red or blonde hair, while lentigines are very common to elderly people.

Since blemishes detract from appearance, earlier efforts used techniques such as skillful application of a manually applied air brush to soften or eliminate them from a retouched photograph. More recently, digital photographs are modifiable with readily available photo editing software, which essentially results in a digitized variant of an air brush operation.

### SUMMARY OF THE INVENTION

In accordance with one embodiment of the subject application, there is provided a system and method for facial image enhancement.

Further, in accordance with one embodiment of the subject application, there is provided a system and method for facial image enhancement to achieve facial smoothing and reduce artifacts without a requirement of laborious manual intervention.

Further, in accordance with one embodiment of the subject application, there is provided a system and method that smoothes the facial skin region in photographs by reducing facial artifacts, but preservers all of the details over the non-facial region.

Still further, in accordance with one embodiment of the subject application, there is provided a system for facial image enhancement. The system comprises means adapted for receiving image data, which image data includes data representative of at least one facial area and isolation means adapted for isolating face region data of the at least one facial area. The system further comprises conversion means adapted for generating luminance data and chrominance data corresponding to image data of the at least one facial area and smoothing means adapted for applying a smoothing algorithm to generated luminance data so as to generate smoothed luminance data. The system also includes means adapted for generating mapping data in accordance with at least one non-skin tone region of the image data and generating means adapted for generating enhanced image data in accordance with smoothed luminance data, chrominance data, and mapping data.

In another embodiment of the subject application, the system further comprises means adapted for generating smoothed face region data in accordance with smoothed luminance data and chrominance data. In such embodiment, the generating means includes means adapted for generating the enhanced image data in accordance with the smoothed face region data and the mapping data.

In a further embodiment of the subject application, the system further comprises means adapted for converting smoothed face region data in RGB color space representation.

In another embodiment of the subject application, the generating means further includes means adapted for generating enhanced image data in accordance with the face region data.

In still another embodiment of the subject application, the system further comprises means adapted for applying a selected threshold range to the face region data to generate the mapping data.

In yet another embodiment of the subject application, the luminance data and chrominance data are represented in YCbCr space.

Still further, in accordance with one embodiment of the subject application, there is provided a method for facial image enhancement according to the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The subject application is described with reference to certain figures, including:

FIG. 1 is an overall diagram of the system for facial image enhancement according to one embodiment of the subject application;

FIG. 2 is a block diagram illustrating controller hardware for use in the system for facial image enhancement according to one embodiment of the subject application;

FIG. 3 is a functional diagram illustrating the controller for use in the system for facial image enhancement according to one embodiment of the subject application;

FIG. 4 is a flowchart illustrating a method for facial image enhancement according to one embodiment of the subject application;

FIG. 5 is a flowchart illustrating a method for facial image enhancement according to one embodiment of the subject application;

FIG. 6 is an example of an image to be processed according to one embodiment of the subject application;

FIG. 7 is an example of a face detection of an image according to one embodiment of the subject application;

FIG. 8 is an example of an isolated face detection of an image according to one embodiment of the subject application;

FIG. 9 is an example of a luminance channel image of an isolated face region of an image according to one embodiment of the subject application;

FIG. 10 is an example of a chrominance (Cr) channel image of an isolated face region of an image according to one embodiment of the subject application;

FIG. 11 is an example of a chrominance (Cb) channel image of an isolated face region of an image according to one embodiment of the subject application;

FIG. 12 is an example of a smooth filtered luminance channel image of an isolated face region of an image according to one embodiment of the subject application;

FIG. 13 is an example of a smooth filtered luminance channel combined with chrominance channels of an isolated face region of an image according to one embodiment of the subject application;

FIG. 14 is an example of an edge map derived from the isolated face region of an image according to one embodiment of the subject application;

FIG. 15 is an example of an edge map threshold of the isolated face region of an image according to one embodiment of the subject application;

FIG. 16 is an example of an inverse and cleaned up threshold map of the isolated face with sliding window for cleanup of the isolated face region of an image according to one embodiment of the subject application;

FIG. 17 is a close up of the contents of the sliding window for clean up of the isolated face region of an image according to one embodiment of the subject application;

FIG. 18 is a close up of a partial cleanup of the contents of the sliding window of the isolated face region of an image according to one embodiment of the subject application;

FIG. 19 is an example of an inverse and cleaned up threshold map of the isolated face region of an image according to one embodiment of the subject application;

FIG. 20 is an example of a non-skin tone segmentation map of the isolated face region of an image according to one embodiment of the subject application;

FIG. 21 is an example of an enhanced image according to one embodiment of the subject application;

FIG. 22 is an example of a blending function according to one embodiment of the subject application;

FIG. 23 is an example of a non-skin segmentation image according to one embodiment of the subject application; and

FIG. 24 is an example of the non-skin segmentation image of FIG. 23 with the application of a blending function according to one embodiment of the subject application.

### DETAILED DESCRIPTION OF THE PREFERRED EMBODIMENT

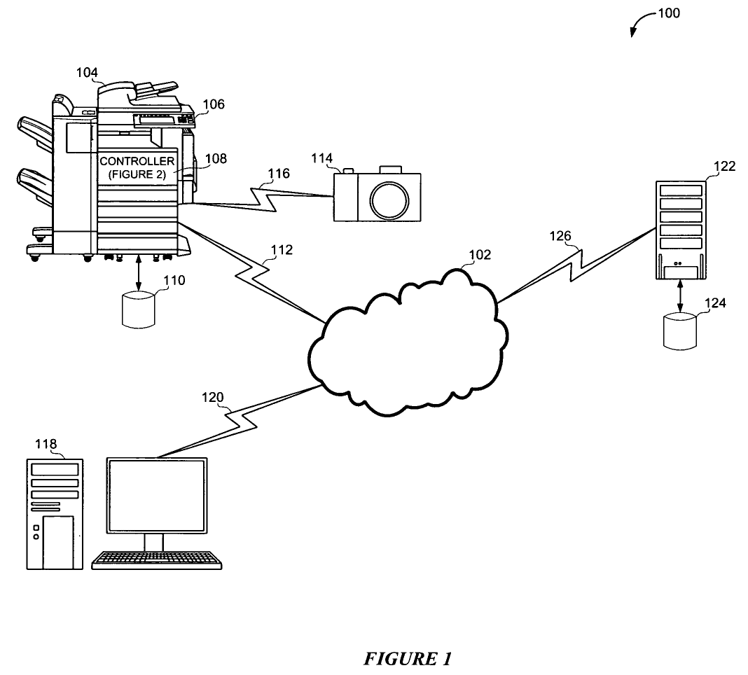

The subject application is directed to a system and method for facial image enhancement. In particular, the subject application is directed to a system and method for facial image enhancement to achieve facial smoothing and reduce artifacts without a requirement of laborious intervention. More particularly, the subject application is directed to a system and method that smoothes the facial skin region in photographs by reducing facial artifacts, but preserves all of the details over the non-facial region. It will become apparent to those skilled in the art that the system and method described herein are suitably adapted to a plurality of varying electronic fields employing user interfaces, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of the system 100 for facial image enhancement in accordance with the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

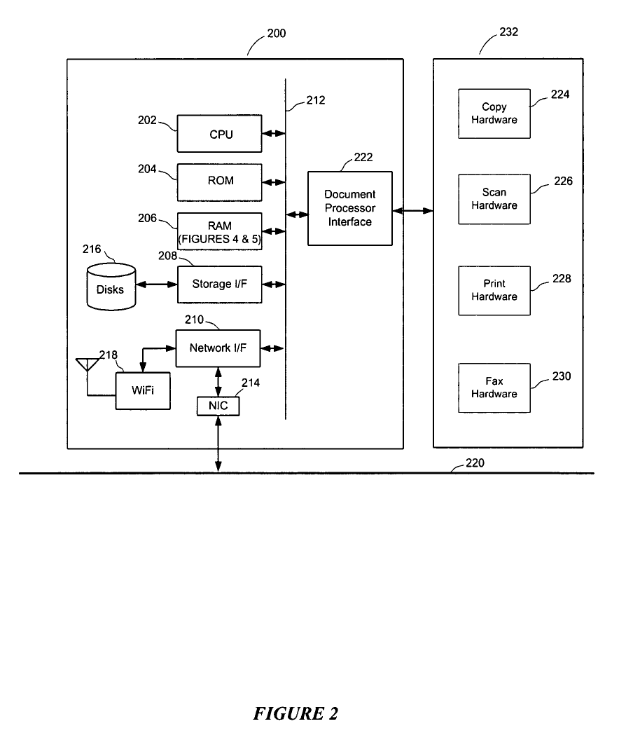

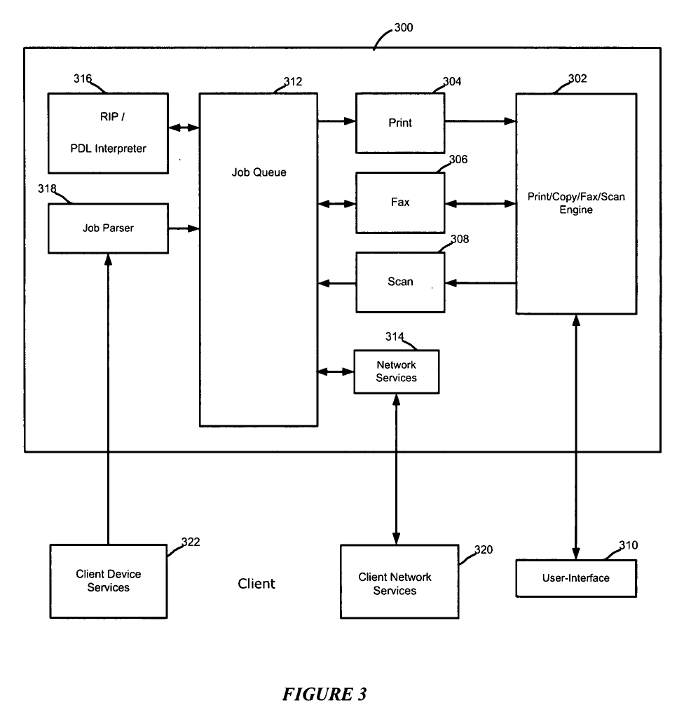

In accordance with the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for facial image enhancement of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store a document data, image data, electronic database data, or the like. It will be appreciated by those skilled in the art that while illustrated in FIG. 1 as being a separate component of the system 100, the data storage device 110 is capable of being implemented as an internal storage component of the document processing device 104, a component of the controller 108, or the like, such as, for example and without limitation, an internal hard disk drive, or the like. In accordance with one embodiment of the subject application, the data storage device 110 includes data representative of images, such as photographic data, computer generated images, electronic documents, or the like.

Illustrated in FIG. 1 is an image capture device, represented as a camera 114, suitably adapted to generate electronic image data. Any suitable photographic device known in the art, is capable of capturing image data for processing in accordance with one embodiment of the subject application. As shown in FIG. 1, the camera 114 is capable of transmitting image data to the document processing device 104 via a suitable communications link 116. As will be appreciated by those skilled in the art, suitable communications links include, for example and without limitation, 802.11a, 802.11b, 802.11g, 802.11(x), Bluetooth, a proprietary communications network, WiMax, infrared, optical, the public switched telephone network, or any suitable wireless data transmission system, or wired communications known in the art. The skilled artisan will further appreciated that in accordance with one particular embodiment of the subject application, the camera 114 includes suitable portable digital media, which is capable of being received by the document processing device 104, containing electronic image data thereon. Suitable portable digital media includes, for example and without limitation, compact flash, xD, SD, memory stick, or other flash random access memory, optical data storage devices, magnetic data storage, or the like. Furthermore, the skilled artisan will also appreciate that the camera 114 is capable of being a general film camera, whereon the communications link 116 is representative of providing a hardcopy of an image to the document processing device 104, which scans the image to generate the image data used in accordance with the subject methodologies described hereinafter. The skilled artisan will appreciate that the camera 114 is also capable of communicating image data to a suitable user device, whereupon the user device communicates the image data to the document processing device 104 for further processing.

The system 100 illustrated in FIG. 1 further depicts a user device 118, in data communication with the computer network 102 via a communications link 120. It will be appreciated by those skilled in the art that the user device 118 is shown in FIG. 1 as a personal computer for illustration purposes only. As will be understood by those skilled in the art, the user device 118 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 120 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 118 is suitably adapted to generate and transmit image data, electronic documents, document processing instructions, user interface modifications, upgrades, updates, personalization data, or the like, to the document processing device 104, or any other similar device coupled to the computer network 102.

The system 100 further illustrates a network storage server 122 coupled to a data storage device 124. Preferably, the network storage server 122 is representative of any network storage device known in the art capable of storing document data, image data, video data, sound data, multimedia data, or other suitable electronic data, as will be known in the art. In accordance with one embodiment of the subject application, the data storage device 124 includes a plurality of electronic data, including image data, document data, or the like. The network storage server 122 is communicatively coupled to the computer network 102 via a suitable communications link 126. As will be understood by those skilled in the art, the communications link 126 includes, for example and without limitation a proprietary communications network, infrared, optical, Bluetooth, WiMax, 802.11a, 802.11b, 802.11g, 802.11(x), the public switched telephone network, or any suitable wireless data transmission system, or wired communications known in the art.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 108 is representative of any general computing device, known in the art, capable of facilitating the methodologies described herein. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by the processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by bus 212.

Also in data communication with the bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2, (shown in FIG. 1 as the controller 108) as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image processor, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The Parser 318 functions to interpret a received electronic document file and relay it to the job queue 312 for handling in connection with the afore-described functionality and components.

In operation, image data, including data of at least one facial area, is first received. Following receipt of the image data, face region data is then isolated. Luminance data and chrominance data are generated corresponding to the facial area data. A smoothing algorithm is thereafter applied to the generated luminance data, which generates smoothed luminance data. Mapping data is then generated according to at least one non-skin tone region of the image data. Enhanced image data is then generated according to the smoothed luminance data, chrominance data, and mapping data.

In accordance with one example embodiment of the subject application, image data is received by the document processing device 104 via any suitable means. As will be appreciated by those skilled in the art, suitable means includes, for example and without limitation, electronic image data received via the computer network 102 from the user device 118, the data storage server 122, the camera 114, or other computing device coupled to the computer network 102; via direct connection with the digital camera 114; via a scanning operation performed by the document processing device; via receipt by the document processing device 104 of a portable storage media; via retrieval from the data storage device 110; or the like. Preferably, the image data received by the document processing device 104 includes at least one facial area, e.g., a representation of the face of a person. The controller 108, or other suitable component of the document processing device 104, then isolates face region data of the at least one facial area. The skilled artisan will appreciate that the controller 108 applies suitable human face detection means, such as, for example and without limitation, by Viola and Jones or by Henry Schneiderman, and thereafter crops or otherwise isolates the detected human face from the received image data.

Luminance and chrominance data are then generated from the image data corresponding to the at least one facial region detected by the document processing device 104. Stated another way, the controller 108, or other suitable component of the document processing device 104 converts the RGB (Red, Blue, Green) color space representation of the facial region to a luminance and chrominance representation, e.g., YCbCr (luminance (Y), chrominance blue-yellow (Cb), red-yellow chrominance (Cr)), HSV (hue (H), saturation (S), value (V)), YIQ (luminance in-phase quadrature, or luminance (Y), orange-blue chrominance (I), purple-green chrominance (Q)), or other device independent color space, as are known in the art. It will further be appreciated by those skilled in the art that the facial artifacts, e.g., freckles, blemishes, scars, cuts, etc., will be viewable in the luminance channel, but hardly in the chrominance channels.

The controller 108, or other suitable component of the document processing device 104, then applies a smoothing algorithm to the luminance data of the facial region, resulting in the generation of smoothed luminance data. As will be appreciated by those skilled in the art, suitable smoothing algorithms include, for example and without limitation, Gaussian filters, Median filters, or the like. The smoothed luminance data and the original chrominance data are combined and then converted back to RGB color space representation to produce an intermediate image. A selected threshold range is then applied to the face region data by the controller 108 or other suitable component of the document processing device 104. Mapping data of a non-skin tone region and smoothed face region data are then generated. In accordance with one embodiment of the subject application, a blending function is capable of being used to generate blending data so as to reduce the artifacts between the smoothed face region and its detail preserving neighbor, e.g., the non-skin tone region. Enhanced image data is then generated according to the smoothed face region data and the mapping data. It will be appreciated by those skilled in the art that use of the blending function in accordance with one embodiment of the subject application results in the generation of enhanced image data in accordance with the smoothed face region data, the mapping data, and the blending data.

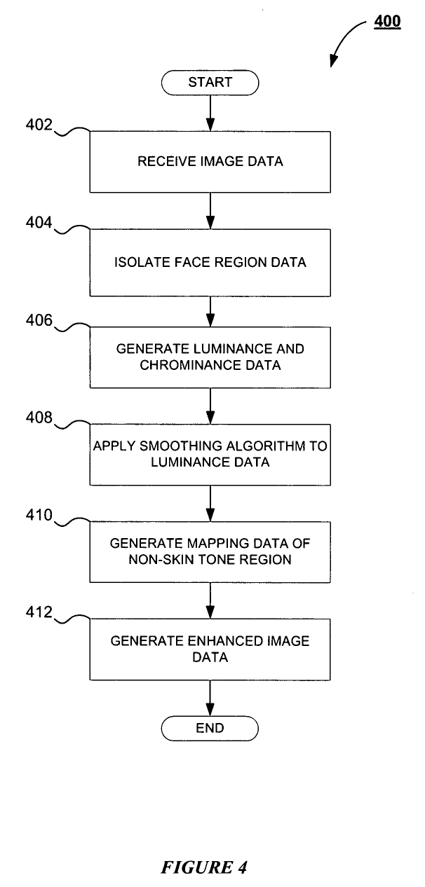

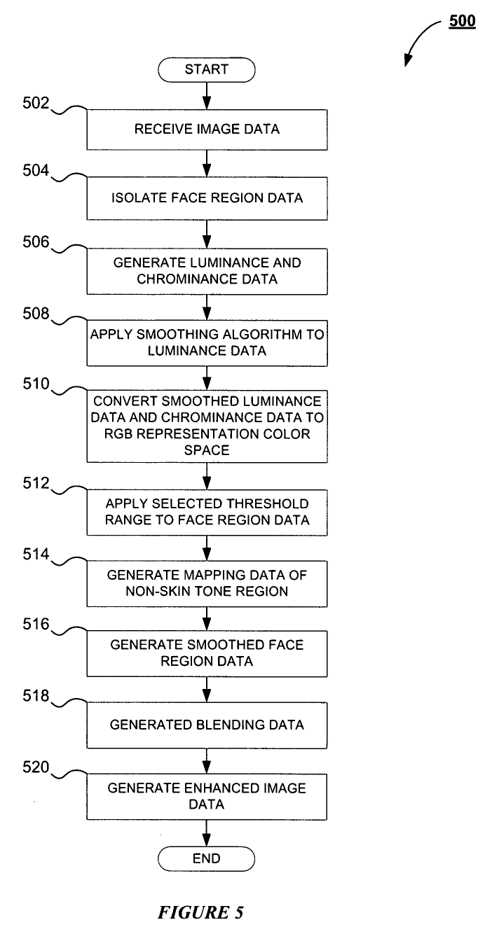

The skilled artisan will appreciate that the subject system 100 and components described above with respect to FIG. 1, FIG. 2, and FIG. 3 will be better understood in conjunction with the methodologies described hereinafter with respect to FIG. 4 and FIG. 5. Turning now to FIG. 4, there is shown a flowchart 400 illustrating a method for facial image enhancement in accordance with the subject application. Beginning at step 402, image data is received, wherein the image data includes data representing at least one facial area. Face region data of the at least one facial area is then isolated at step 404. At step 406, luminance data and chrominance data are generated corresponding to the image data of the at least one facial area. A smoothing algorithm is then applied to the luminance data at step 408, so as to generate smoothed luminance data. Mapping data of a non-skin tone region of the image data is then generated at step 410. Enhanced image data is then generated at step 412 according to the smoothed luminance data, the chrominance data, and the mapping data.

Referring now to FIG. 5, there is shown a flowchart 500 illustrating a method for facial image enhancement in accordance with the subject application. The method begins at step 502, wherein image data, including data representing a facial area, is received. The skilled artisan will appreciate that suitable image data is capable of being received via the computer network 102 from the user device 118, the network storage server 122, the camera 114, or the like; via a portable storage media; via the data storage device 110; via generation of image data from a document by a scanning operation of the document processing device; via facsimile receipt of image data by the document processing device 104; or other suitable means known in the art.

At step 504, face region data is isolated corresponding to facial area. In accordance with one embodiment of the subject application, an input image is received by the controller 108 of the associated document processing device 104 and subjected to a face detection scheme. When a facial area is identified, it is then isolated, e.g., cropped, resulting in face region data. Luminance and chrominance data are then generated corresponding to image data of the facial area at step 506. In accordance with one embodiment of the subject application, the facial area is then converted to a luminance-chrominance color space, such as, for example and without limitation, YCbCr, HSV, YIQ, or other device independent color space that contains separate luminance and chrominance channels.

A smoothing algorithm is then applied to the luminance data at step 508 so as to generate smoothed luminance data. Stated another way, the luminance channel data is subjected to a smoothing filter, as will be understood by those skilled in the art, resulting in smoothed luminance channel data. The smoothed luminance data and the chrominance data are then converted to an RGB representation color space at step 510. That is, the smoothed luminance channel and the original chrominance channels are recombined into a single channel, i.e., RGB color space, resulting in smoothed face region data. A selected threshold range is then applied to the face region data at step 512. At step 514, mapping data of a non-skin tone region is generated. It will be appreciated by those skilled in the art that the generation of the mapping data of the non-skin tone region is performed in accordance with an empirically determined threshold value. Smoothed face region data is then generated at step 516. In accordance with one embodiment of the subject application, blending data is generated via a suitable blending function, which determines a weighing factor to smooth the transition between the mapping data and the smoothed face region data at step 518. Thereafter, enhanced image data is generated at step 520 according to the smoothed face region data, the mapping data, and the blending data. The skilled artisan will appreciate that step 518 is for example purposes only, and the subject application is capable of generating enhanced image data using only the smoothed face region data and the mapping data.

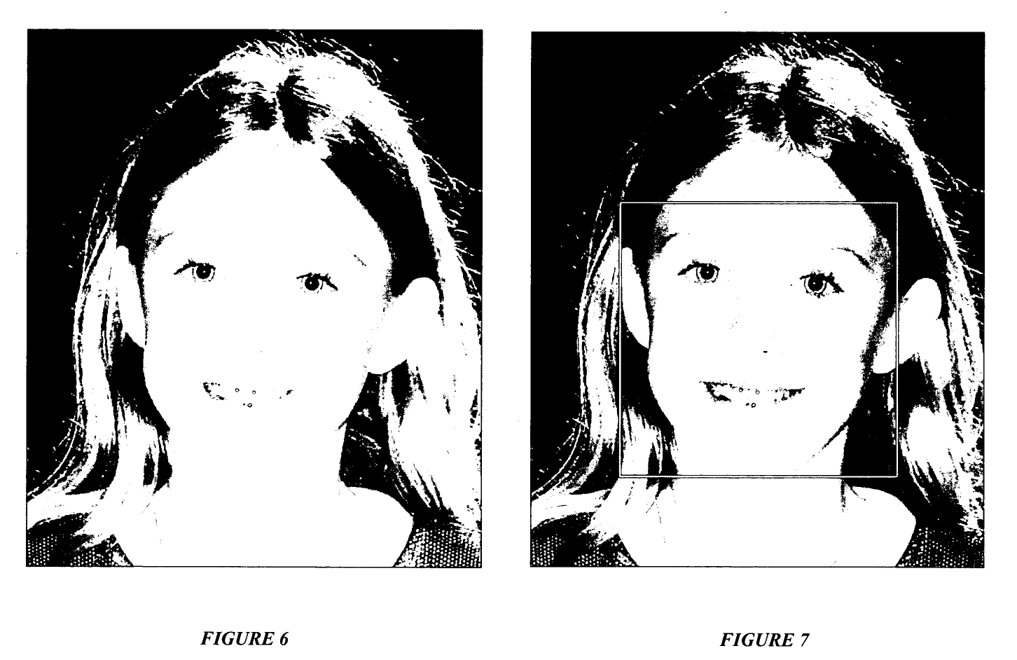

The preceding system and methodologies will better be understood when viewed in conjunction with the example image processing of FIGS. 6, 7, 8, 9, 10, 11, 12, 13, 14, 15, 16, 17, 18, 19, 20, and 21. It will be understood by those skilled in the art that the following description of FIGS. 6-21 is for example purposes only and is not intended to limit the subject application thereto.

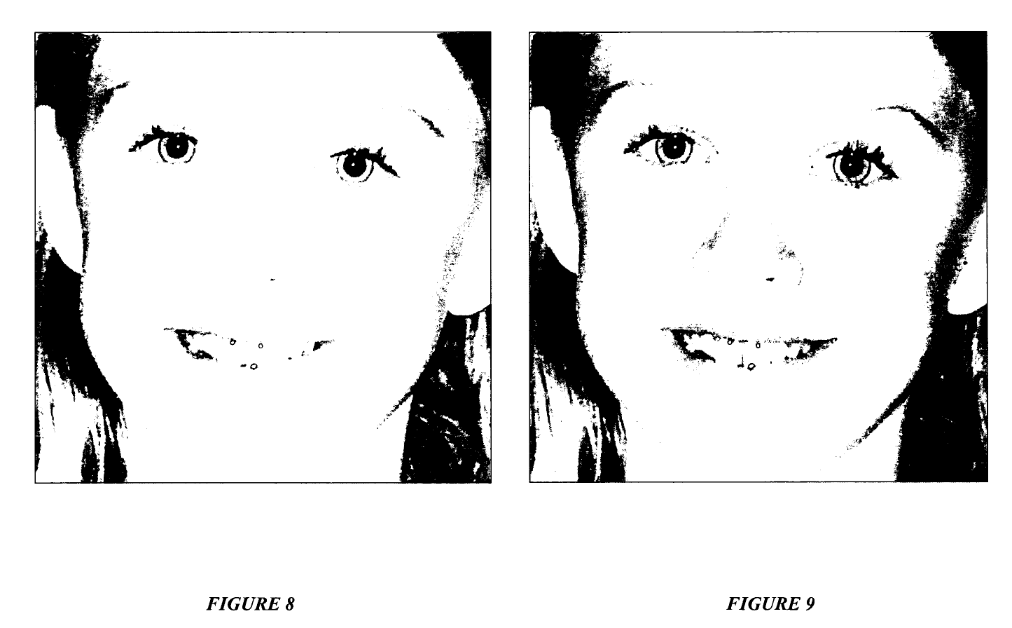

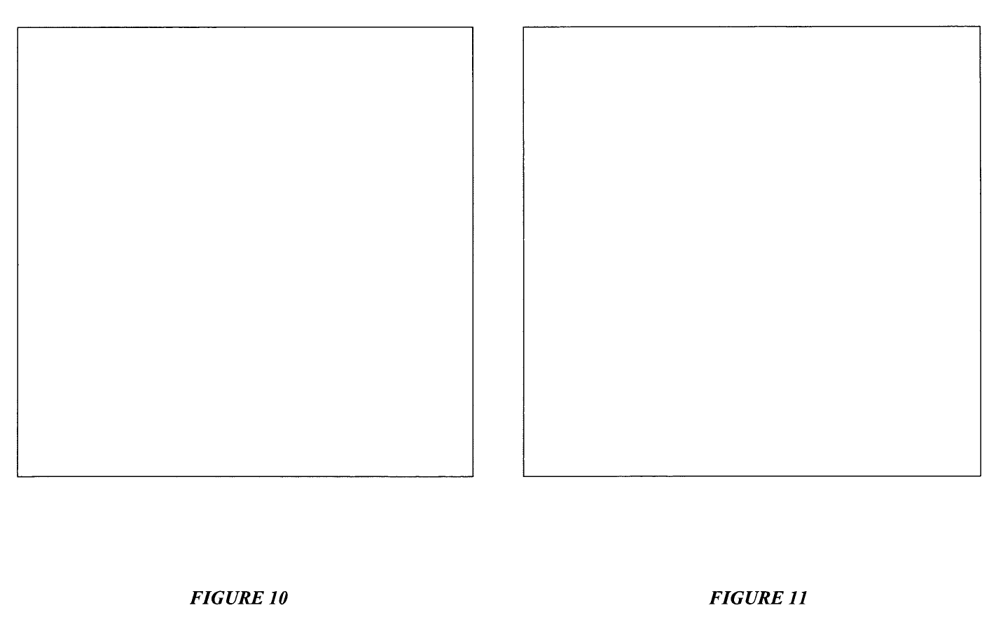

Turning now to FIG. 6, there is shown an input image, from which a human face is detected, illustrated by the box of in FIG. 7. The box is cropped from the original image, resulting in the isolated face region shown in FIG. 8. The isolated face region is then converted from RGB color space representation to YCbCr color space representation. As previously stated, any device independent luminance/chrominance color space is capable of being used in accordance with the methodologies described herein. FIG. 9 illustrates the luminance channel of the isolated face region, FIG. 10 illustrates the chrominance Cb channel of the isolated face region, and FIG. 11 illustrates the chrominance Cr channel of the isolated face region. As will be appreciated by those skilled in the art, facial artifacts are readily apparent in the luminance channel of the isolated face region (FIG. 9), but are hardly visible in the chrominance channels (FIGS. 10 and 11).

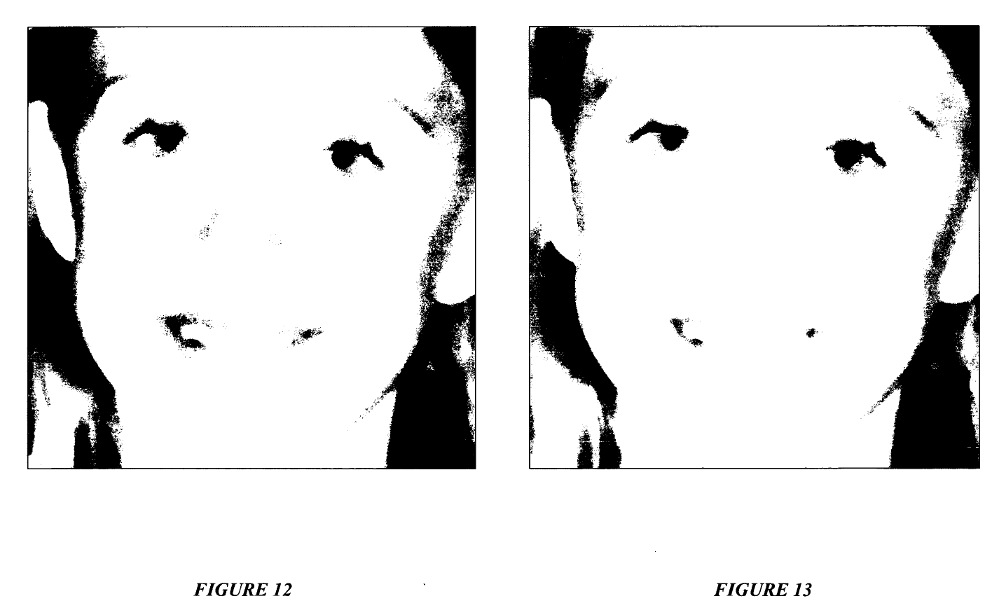

A smoothing filter is then applied to the isolated face region in the luminance channel, resulting in the image illustrated in FIG. 12. The new luminance channel is then combined with the original chrominance channels to produce an intermediate image, which is depicted in FIG. 13. Further processing is accomplished in the non-skin tone region, which results in details for use in the final enhanced image, shown in FIG. 21.

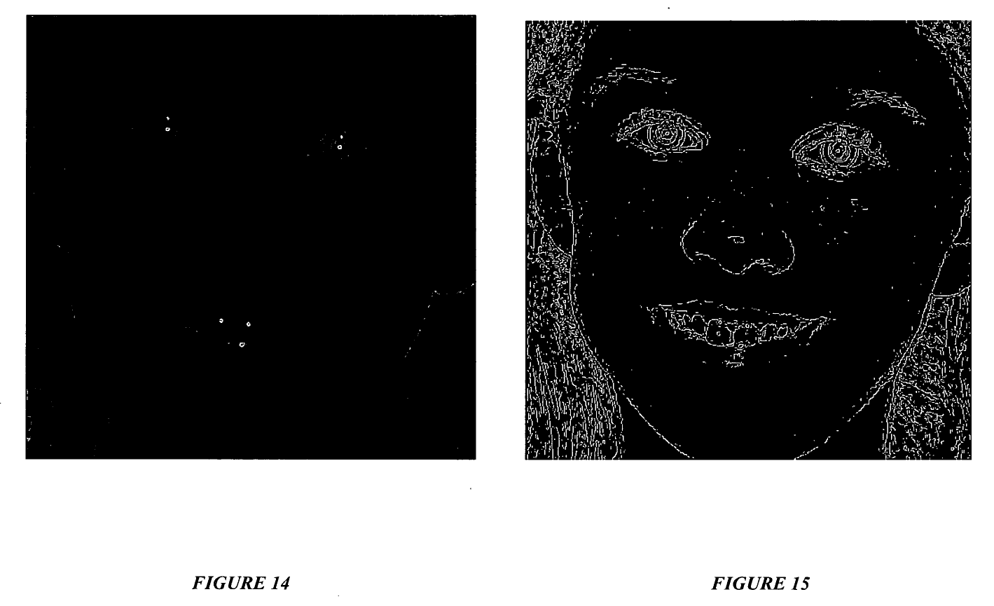

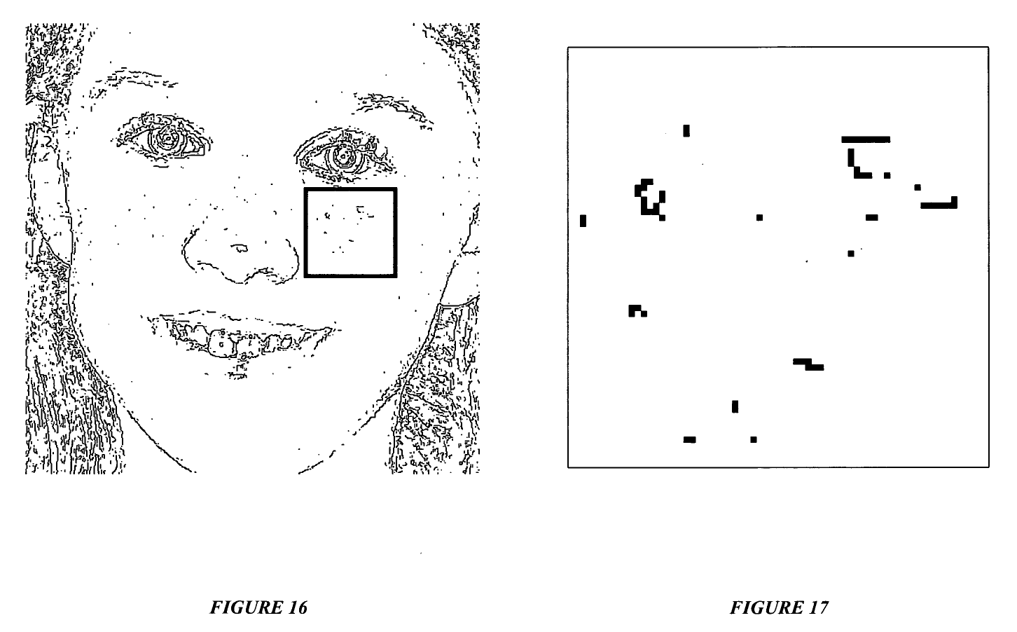

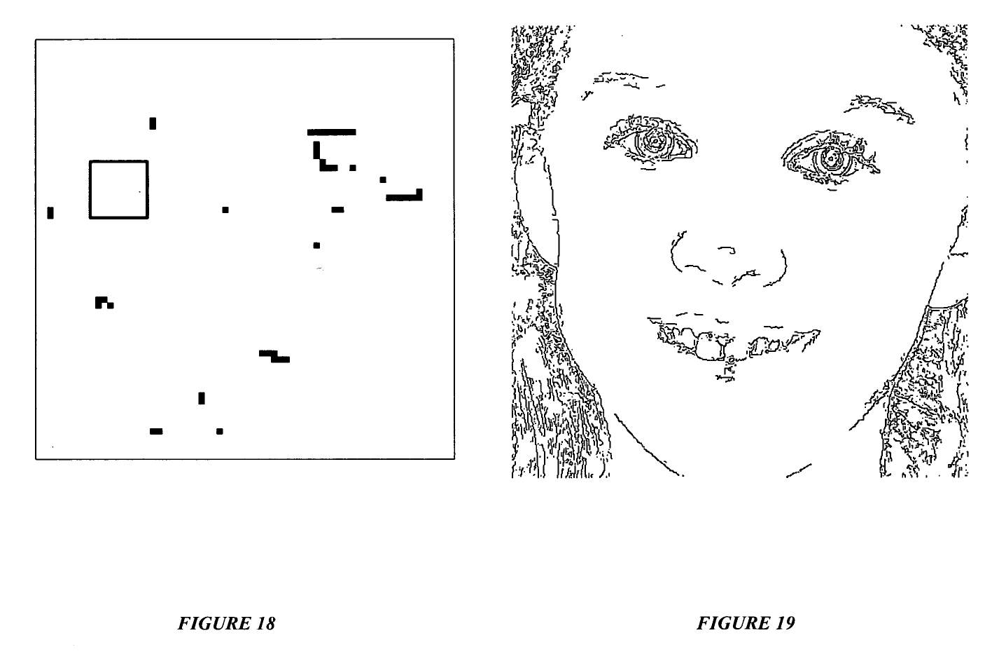

In order to obtain the non-skin tone region details, facial region segmentation is performed. The segmentation begins with the generation, or derivation, of an edge map, based upon the original face region, as shown in FIG. 14. An empirically determined threshold value is then applied to the edge map, resulting in the threshold map of FIG. 15. The threshold map of FIG. 15 is subsequently inversed, resulting in the inverse threshold map shown in FIG. 16. Also shown in FIG. 16 is the application of a sliding window, which is applied to clean up the fragments, e.g., the facial blemishes, freckles, scars, marks, and the like. It will be appreciated by those skilled in the art that the clean up of the fragments is accomplished within a window having a size that is determined by the dimensions of the face region. FIG. 17 illustrates a close up view of the contents of the sliding window, showing the facial fragments. FIG. 18 includes a box, which functions to remove, erase, or otherwise cover up the facial fragments within the sliding window.

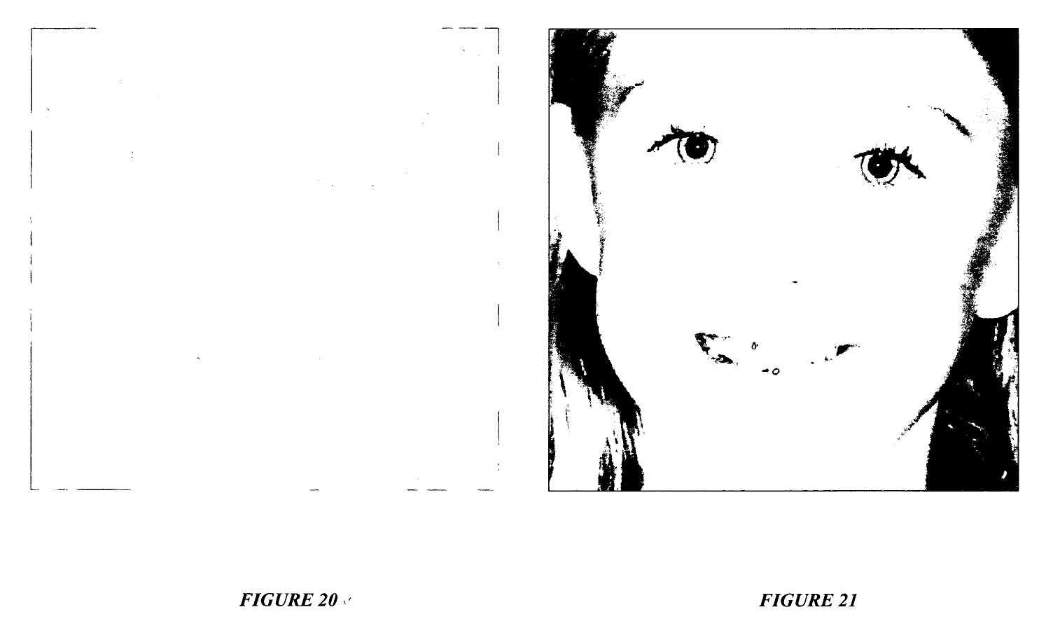

A cleaned up inverse threshold map is illustrated in FIG. 19. A smearing filter is applied to the inversed and cleaned up map of FIG. 19, resulting in the non-skin tone segmentation map depicted in FIG. 20. It will be appreciated by those skilled in the art that the size of the smearing filter is determined by the dimensions of the face region. The non-skin tone segmentation map depicted in FIG. 20 is then combined with the intermediate image of FIG. 13, resulting in the enhanced image depicted in FIG. 21.

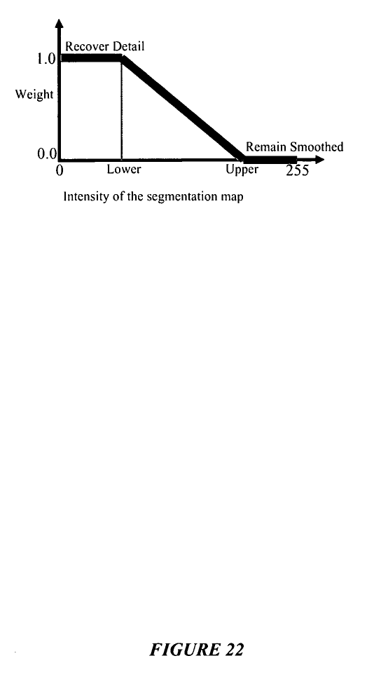

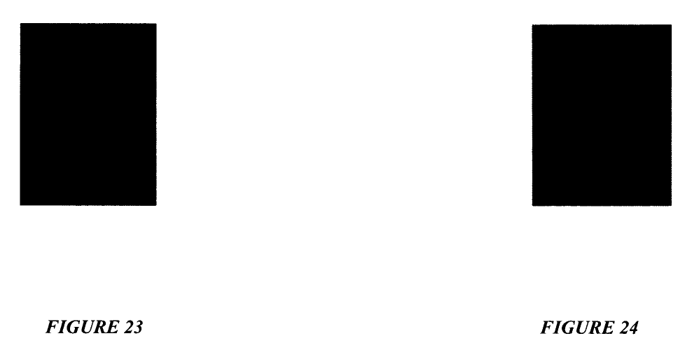

It will be appreciated by those skilled in the art that the subject system and method is capable of general application for facial smoothing using the same non-skin tone region segmentation. It will further be understood by the skilled artisan that to reduce the artifacts between a smoothed region and its detail preserving neighbor, a blending function is implemented. A suitable blending function is shown in the graphical representation of FIG. 22. The blending function, as shown in FIG. 22, will be understood by those skilled in the art to determine a weighting factor to smooth the transition between full detail recovery and full smoothing, which is a function of the intensity in the non-skin tone segmentation map. FIG. 23 illustrates a non-skin segmentation example prior to the application of the blending function. FIG. 24 illustrates the non-skin segmentation of FIG. 23 with the application of the blending function.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A facial image enhancement system comprising:
means adapted for receiving image data, which image data includes data representative of at least one facial area;
isolation means adapted for isolating face region data of the at least one facial area;
conversion means adapted for generating luminance data and chrominance data corresponding to image data of the at least one facial area;
smoothing means adapted for applying a smoothing algorithm to generated luminance data so as to generate smoothed luminance data;
means adapted for generating mapping data in accordance with at least one non-skin tone region of the image data; and
generating means adapted for generating enhanced image data in accordance with smoothed luminance data, chrominance data, and mapping data.

2. The facial image enhancement system of claim 1 further comprising means adapted for generating smoothed face region data in accordance with smoothed luminance data and chrominance data, and wherein the generating means includes means adapted for generating the enhanced image data in accordance with the smoothed face region data and the mapping data.

3. The facial image enhancement system of 2 further comprising means adapted for converting smoothed face region data in RGB color space representation.

4. The facial image enhancement system of 2 wherein the generating means further includes means adapted for generating enhanced image data in accordance with the face region data.

5. The facial image enhancement system of 4 further comprising means adapted for applying a selected threshold range to the face region data to generate the mapping data.

6. The facial image enhancement system of 5 wherein the luminance data and chrominance data are represented in YCbCr space.

7. The facial image enhancement system of claim 5, further comprising means adapted for generating blending data representative of a blending of the mapping data and the smoothed face region data, wherein the generating means includes means adapted for generating the enhanced image data in accordance with the smoothed face region data, the mapping data, and the blending data.

8. A method for facial image enhancement comprising the steps of:
receiving image data, which image data includes data representative of at least one facial area;
isolating face region data of the at least one facial area;
generating luminance data and chrominance data corresponding to image data of the at least one facial area;
applying a smoothing algorithm to generated luminance data so as to generate smoothed luminance data;
generating mapping data in accordance with at least one non-skin tone region of the image data; and
generating enhanced image data in accordance with smoothed luminance data, chrominance data, and mapping data.

9. The method for facial image enhancement of claim 8 further comprising the step of generating smoothed face region data in accordance with smoothed luminance data and chrominance data, and wherein the step of generating enhanced image data includes generating the enhanced image data in accordance with the smoothed face region data and the mapping data.

10. The method for facial image enhancement of 9 further comprising the step of converting smoothed face region data in RGB color space representation.

11. The method for facial image enhancement system of 9 wherein the step of generating enhanced image data includes generating enhanced image data in accordance with the face region data.

12. The method for facial image enhancement system of 11 further comprising the step of applying a selected threshold range to the face region data to generate the mapping data.

13. The method for facial image enhancement system of 12 wherein the luminance data and chrominance data are represented in YCbCr space.

14. The method for facial image enhancement of claim 12, further comprising the step of generating blending data representative of a blending of the mapping data and the smoothed face region data, wherein the step of generating enhanced image data includes generating the enhanced image data in accordance with the smoothed face region data, the mapping data, and the blending data.

15. A computer-implemented method for facial image enhancement comprising the steps of:
receiving image data, which image data includes data representative of at least one facial area;
isolating face region data of the at least one facial area;
generating luminance data and chrominance data corresponding to image data of the at least one facial area;
applying a smoothing algorithm to generated luminance data so as to generate smoothed luminance data;
generating mapping data in accordance with at least one non-skin tone region of the image data; and
generating enhanced image data in accordance with smoothed luminance data, chrominance data, and mapping data.

16. The computer-implemented method for facial image enhancement of claim 15 further comprising the step of generating smoothed face region data in accordance with smoothed luminance data and chrominance data, and wherein the step of generating enhanced image data includes generating the enhanced image data in accordance with the smoothed face region data and the mapping data.

17. The computer-implemented method for facial image enhancement of 16 further comprising the step of converting smoothed face region data in RGB color space representation.

18. The computer-implemented method for facial image enhancement system of 16 wherein the step of generating enhanced image data includes generating enhanced image data in accordance with the face region data.

19. The computer-implemented method for facial image enhancement system of 18 further comprising the step of applying a selected threshold range to the face region data to generate the mapping data.

20. The computer-implemented method for facial image enhancement system of 19 wherein the luminance data and chrominance data are represented in YCbCr space.
